(19) United States
(12) Patent Application Publication
(10) Pub. No.: US 2014/0129979 A1
(43) Pub. Date: May 8, 2014

(54) DISPLAY DEVICE AND LIST DISPLAY METHOD THEREOF

(71) Applicant: Samsung Electronics Co., Ltd., Suwon-si (KR)

(72) Inventors: Hee-jeong BAE, Osan-si (KR); Yong-hwan KWON, Seongnam-si (KR); Jang-won SEO, Seoul (KR); Myung-kwan CHOI, Suwon-si (KR); Yoo-jin CHOI, Seoul (KR); Woo-seok HWANG, Seoul (KR)

(73) Assignee: Samsung Electronics Co., Ltd., Suwon-si (KR)

(21) Appl. No.: 14/070,909

(22) Filed: Nov. 4, 2013

(30) Foreign Application Priority Data
Nov. 2, 2012 (KR) 10-2012-0123650

(51) Int. Cl. G06F 3/0482

(52) U.S. Cl. CPC G06F 3/0482
USPC 715/810

(57) ABSTRACT

A display device and a list display method thereof are provided. In the list display method, a list including a plurality of items is displayed, and if a user's manipulation is input, a highlight displayed on one item of the plurality of items moves to another item in a direction corresponding to the user's manipulation, and moves the plurality of items in the opposite direction of the direction corresponding to the user's manipulation. Accordingly, the user may maintain continuity of search with respect to items included in a list even when moving a highlight.

### CROSS-REFERENCE TO RELATED APPLICATION

This application claims priority from Korean Patent Application No. 10-2012-0123650, filed on Nov. 2, 2012, in the Korean Intellectual Property Office, the disclosure of which is incorporated herein by reference in its entirety.

### BACKGROUND

1. Field

Apparatuses and methods consistent with exemplary embodiments relate to a display device and a list display method thereof, and more particularly, to a display method capable of displaying a list including a plurality of items and selecting an item from the plurality of items using a highlight, and a list display method thereof.

2. Description of the Related Art

With the development of technologies, many display devices can perform various functions, such as an Internet search function, an application execution function, etc., in addition to a function of receiving a broadcast. In order to perform such various functions, a user controls the functions of a display device using a list including a plurality of items.

Meanwhile, a conventional display device is used to select an item from a list including a plurality of items by moving a highlight between the items. At this time, the conventional display device moves only the highlight without moving the items.

Also, if a highlight is positioned in the lowermost or rightmost area of a screen, the conventional display device moves only items in the opposite direction of the movement direction of the highlight while fixing the highlight according to a user's manipulation (a first method), or moves the highlight onto the uppermost or leftmost one of items shown on the screen by changing the page of the list (a second method).

However, the first method of only moving items in the opposite direction while fixing a highlight has a problem in that a user cannot check the following item in advance. Also, the second method of changing the page of a list has a problem that a user cannot check the previously displayed items due to a screen change.

### SUMMARY

Exemplary embodiments overcome the above disadvantages and other disadvantages not described above. Also, exemplary embodiments are not required to overcome the disadvantages described above, and an exemplary embodiment may not overcome any of the problems described above.

An exemplary embodiment provides a display device capable of moving, if a highlight movement command is input, a highlight displayed on one of a plurality of items to another item in a direction corresponding to a user's manipulation, and moving the plurality of items in the opposite direction of the direction corresponding to the user's manipulation, and a list display method of the display device.

A method according to an exemplary embodiment includes a first display operation of displaying a list including a plurality of items, and a second display operation of moving, if a manipulation is input, a highlight displayed on one item of the plurality of items to another item in a direction corresponding to the manipulation, and moving the plurality of items in an opposite direction of the direction corresponding to the manipulation. The manipulation may be performed by a user.

The list may be a list in which some of the plurality of items are displayed on a display screen.

The second display operation may include determining a movement distance of the highlight using a number of the plurality of items included in the list.

If the plurality of items included in the list are arranged horizontally, and a row of the list includes N items, the determining of the movement distance of the highlight may include determining 1/N of the width of the list as the movement distance of the highlight.

If the plurality of items included in the list are arranged vertically, and a column of the list includes M items, the determining of the movement distance of the highlight may include determining 1/M of the height of the list as the movement distance of the highlight.

If the plurality of items included in the list are arranged horizontally, an indicator may be displayed at a first center area of the plurality of items in a width direction, and if the plurality of items included in the list are arranged vertically, an indicator may be displayed at a second center area of the plurality of items in a height direction.

A device according to an exemplary embodiment includes a display configured to display a list including a plurality of items, an inputter configured to receive a manipulation, and a controller configured to move, if the manipulation is input through the inputter, a highlight displayed on one item of the plurality of items to another item in a direction corresponding to the manipulation, and to move the plurality of items in an opposite direction of the direction corresponding to the manipulation.

The list may be a list in which some of the plurality of items are displayed on a display screen.

The controller may determine a movement distance of the highlight using a number of the plurality of items included in the list.

If the plurality of items included in the list are arranged horizontally, and a row of the list includes N items, the controller may determine 1/N of the width of the list as a movement distance of the highlight.

If the plurality of items included in the list are arranged vertically, and a column of the list includes M items, the controller may determine 1/M of the height of the list as the movement distance of the highlight.

If the plurality of items included in the list are arranged horizontally, the controller may display an indicator at a first center area of the items in a width direction, and if the plurality of items included in the list are arranged vertically, the controller may display an indicator at a second center area of the plurality of items in a height direction.

Additional and/or other aspects and advantages of exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the exemplary embodiments will be more apparent with reference to the accompanying drawings, in which:

FIG. 1 is a block diagram showing the configuration of a display device according to an exemplary embodiment;

FIG. 2 is a block diagram showing in detail the configuration of a display device according to an exemplary embodiment;

FIGS. 3A through 4B are views for explaining a highlight moving method according to an exemplary embodiment; and

FIG. 5 is a flowchart showing a list display method of a display device according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding. Thus, it is apparent that the exemplary embodiments can be carried out without those specifically defined matters. Also, well-known functions or constructions are not described in detail since they would obscure the disclosure with unnecessary detail.

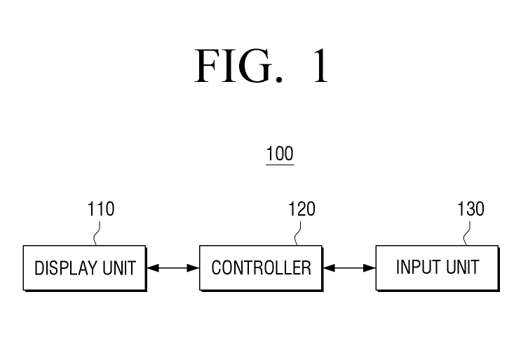

Hereinafter, exemplary embodiments will be described in detail with reference to FIG. 1.

FIG. 1 is a block diagram showing the configuration of a display device 100 according to an embodiment. As shown in FIG. 1, the display device 100 includes a display unit 110, a controller 120, and an input unit 130. Here, the display device 100 may be a smart TV, however, the display device 100 is not limited to a smart TV. That is, the display device 100 may be implemented as one of various display devices, such as a monitor, a projector, a tablet PC, a mobile phone, etc.

The display unit 110 outputs image data according to the control of the controller 140. Particularly, the display unit 110 may display a list including a plurality of items. The list including the plurality of items is a list in which a plurality of items cannot all be displayed on a screen. Also, the display unit 110 may display a highlight on one of the plurality of items included in the list, and the highlight may move to another item according to a user's manipulation.

The input unit 130 receives a user command for controlling the display device 100. For example, the input unit 130 may receive a command for moving a highlight on a list including a plurality of items.

Meanwhile, the input unit 130 is a device capable of moving an item in up, down, left, and right directions, and may be a remote controller. However, the input unit 130 is not limited to a remote controller, and may be implemented as one of various input devices, such as a touch screen, a pointing device, etc.

The controller 120 may control the entire operation of the display device 100 according to a user's command input through the input unit 130. For example, if a user's manipulation is input through the input unit 130 when a list including a plurality of items is displayed on the display unit 110, the controller 120 may control the display unit 110 to move a highlight displayed on one of the plurality of items to another item in a direction corresponding to the user's manipulation, and move the plurality of items in the opposite direction of the direction corresponding to the user's manipulation.

In detail, the controller 120 may control the display unit 110 to display a list including a plurality of items. Here, the list may be a list in which some of a plurality of items are displayed on a display screen. For example, the list may be a list in which only four items among a total of 10 items can be displayed on a display screen. Also, the controller 120 may control the display unit 110 to overlap a highlight on one of a plurality of items displayed on a screen.

If a user's manipulation for moving a highlight is input through the input unit 130, the controller 120 may control the display unit 110 to move the highlight displayed on one of the plurality of items to another item in a direction corresponding to the user's manipulation, and to move the plurality of items displayed on the screen in the opposite direction of the direction corresponding to the user's manipulation.

For example, if a user's manipulation for moving a highlight to the right is input through the input unit 130, the controller 120 may control the display unit 110 to move a highlight displayed on one of a plurality of items to another item positioned to the right and to simultaneously move the plurality of items to the left. At this time, the controller 120 may control the display unit 110 to remove at least a part of an item positioned near the left edge of the screen, and to display at least a part of a new item near the right edge of the screen.

Accordingly, the user may maintain continuity of search with respect to items included in a list even when moving a highlight.

Also, the controller 120 may determine the movement distance of the highlight based on the number of the plurality of items included in the list. In detail, if a plurality of items included in a list are arranged horizontally, and one row of the list includes N items, the controller 120 may determine 1/N of the width of the list as the movement distance of a highlight. Also, if a plurality of items included in a list are arranged vertically, and one column of the list includes M items, the controller 120 may determine 1/M of the height of the list as the movement distance of a highlight. For example, if a plurality of items included in a list are arranged horizontally, and one row of the list include 10 items, the controller 120 may determine 1/10 of the width of the list as the movement distance of a highlight.

Accordingly, the user can determine a relative position of an item currently overlapped by a highlight, according to the position of the highlight.

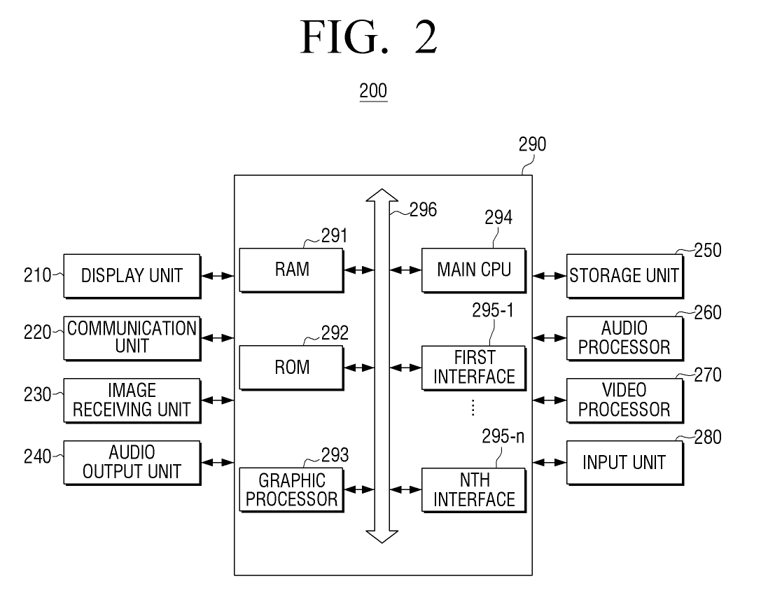

The display device will be described in more detail with reference to FIGS. 2 through 6. FIG. 2 is a block diagram showing in detail the configuration of a display device 200 according to an exemplary embodiment. As shown in FIG. 2, the display device 200 includes a display unit 210, a communication unit 220, an image receiving unit 230, an audio output unit 240, a storage unit 250, an audio processor 260, a video processor 270, an input unit 280, and a controller 290.

Meanwhile, FIG. 2 relates to an example in which the display device 200 includes components for performing various functions, such as a communication function, a broadcast receiving function, a video play function, a display function, etc. Accordingly, some of the components shown in FIG. 2 may be omitted or modified, or other components may be added.

The display unit 210 displays at least one of video frames and various screens, wherein the video frames are created by processing image data received by the image receiving unit 230 in the video processor 270, and the various screens are created by a graphic processor 293. Particularly, the display unit 210 may display a list including a plurality of items.

The communication unit 220 is used to communicate with various kinds of external devices according to various types of communication methods. The communication unit 220 may include various communication chips, such as a WiFi chip, a Bluetooth chip, a near field communication (NFC) chip, a wireless communication chip, etc. The WiFi chip, the Bluetooth chip, and the NFC chip perform communications by a WiFi method, a Bluetooth method, and an NFC method, respectively. The NFC chip is a chip that operates by the NFC method using a 13.56 MHz band among various radio frequency (RF)-ID frequency bands of 135 kHz, 13.56 MHz, 433 MHz, 860 through 960 MHz, 2.45 GHz, etc. In the case of using the WiFi chip or Bluetooth chip, various connection information, such as a service set identifier (SSID), a session key, etc. may be first transmitted and received to perform access using the connection information, and then various information may be transmitted and received. The wireless communication chip is a chip that performs communication according to various communication standards, such as IEEE, Zigbee, 3^{rd} Generation (3G), 3^{rd} Generation Partnership Project (3GPP), Long Term Evolution (LTE), etc.

The image receiving unit 230 receives image data through various sources. For example, the image receiving unit 230 may receive broadcast data from a broadcasting station, or image data from an external device (for example, a DVD device).

The audio output unit 240 is used to output various notice sounds or voice messages, as well as various audio data processed by the audio processor 260.

The storage unit 250 stores various modules for driving the display device 200. For example, the storage unit 250 may store software including a base module, a sensing module, a communication module, a presentation module, a web browser module, and a service module. The base module is a basic module that processes signals transferred from individual hardware included in the display device 200, and transfers the processed signals to the upper layer module. The sensing module is a module for collecting information from various sensors, and analyzing and managing the collected information, and may include a face recognition module, a voice recognition module, a motion recognition module, an NFC recognition module, etc. The presentation module is a module for configuring a display screen, and may include a multimedia module for reproducing and outputting multimedia content, and a UI rendering module for performing UI and graphic processing. The communication module is a module for communicating with external devices. The web browser module is a module for performing web browsing to access a web server. The service module is a module including various kinds of applications for providing various services.

Although the storage unit 250 can include various program modules as described above, some of the program modules may be omitted or modified, or other program modules may be added. If the display device 200 is a tablet PC, the base module may further include a location determination module for determining a location based on GPS, and the sensing module may further include a motion sensing module for sensing a user's motion.

The audio processor 260 is used to process audio data. The audio processor 260 may perform various processing, such as decoding, amplification, noise filtering, etc., on audio data. Audio data processed by the audio processor 260 may be output to the audio output unit 240.

The video processor 270 is used to process image data received by the image receiving unit 230. The video processor 270 may perform various image processing, such as decoding, scaling, noise filtering, frame rate conversion, resolution conversion, etc., on image data.

The input unit 280 receives a user's command for controlling the entire operation of the display device 200. Particularly, the input unit 280 may receive a user's manipulation for moving a highlight positioned on one of a plurality of items.

The input unit 280 may be implemented as a remote controller capable of moving a highlight in the up, down, left, or right direction. However, the input unit 280 may be implemented as another type of input device capable of controlling the display device 200, such as a touch panel, a pointing device, etc.

The controller 290 controls the entire operation of the display device 200 using various programs stored in the storage unit 250.

The controller 290 includes, as shown in FIG. 1, a random-access memory (RAM) 291, a read-only memory (ROM) 292, a graphic processor 293, a main CPU 294, first through n^{th} interfaces 295-1 through 295-n, and a bus 296. Here, the RAM 291, the ROM 292, the graphic processor 293, the main CPU 294, the first through n^{th} interfaces 295-1 through 295-n, etc. may be connected to each other through the bus 296.

The ROM 292 stores a command set, etc. for system booting. If a turn-on command is input so that power is supplied, the main CPU 294 copies an O/S stored in the storage unit 250 to the RAM 291 according to a command stored in the ROM 292, and executes the O/S to boot the system. If booting is completed, the main CPU 294 copies various application programs stored in the storage unit 250 to the RAM 291, and executes the application programs copied to the RAM 291 to perform various operations.

The graphic processor 293 creates a screen including various objects, such as icons, images, text, etc., using a calculating unit (not shown) and a rendering unit (not shown). The calculating unit calculates attribute values, such as coordinate values, shapes, sizes, colors, etc., of individual objects, according to the layout of a screen, using a control command received through the input unit 280. The rendering unit creates various layouts of screens including the objects, based on the attribute values calculated by the calculating unit. The screens created by the rendering unit are displayed on the display area of the display unit 210.

The main CPU 294 accesses the storage unit 250 to perform booting using the O/S stored in the storage unit 250. Also, the main CPU 294 performs various operations using various programs, contents, data, etc. stored in the storage unit 250.

The first through n^{th} interfaces 295-1 through 295-n are connected to various components described above. One of the interfaces 295-1 through 295-n may be a network interface that is connected to an external device through a network.

For example, if a user's manipulation is input through the input unit 280, the controller 290 may control the display unit 210 to move a highlight displayed on one of a plurality of items to another item in a direction corresponding to the user's manipulation, and to move the plurality of items in the opposite direction of the direction corresponding to the user's manipulation.

In detail, the controller 290 may control the display unit 210 to display a list including a plurality of items.

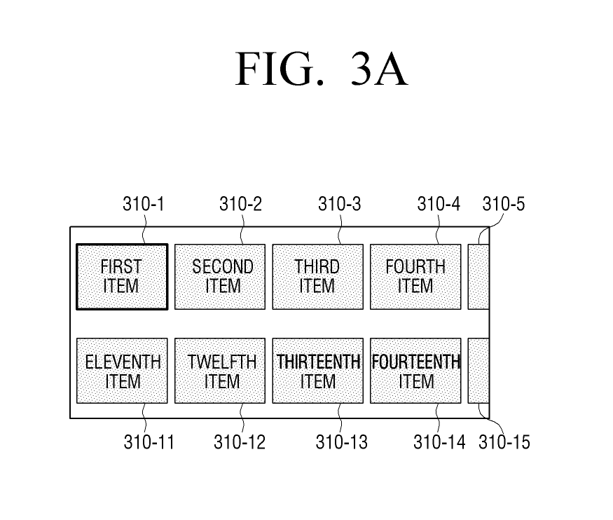

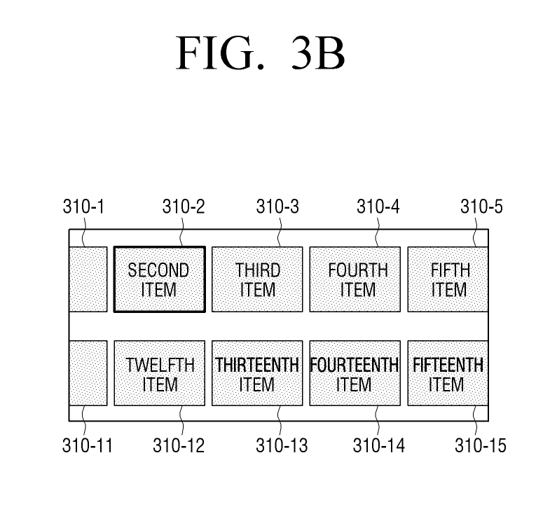

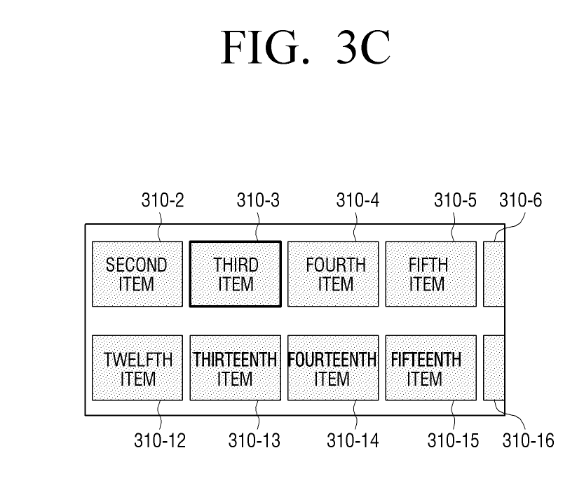

Here, the display unit 210 may display some of the plurality of items since it cannot display all of the items. For example, if a total of 20 items 310-1 through 310-20 are displayed in two rows, the display unit 210 may display, as shown in FIG. 3A, the first through fourth items 310-1 through 310-4 and the eleventh through fourteenth items 310-11 through 310-14 among the 20 items 310-1 through 310-20 on a display screen.

Also, the controller 290 may control the display unit 210 such that a highlight overlaps one of the plurality of items. For example, as shown in FIG. 3A, the controller 290 may control the display unit 210 such that a highlight is displayed to overlap the first item 310-1.

Also, if a user's manipulation is input through the input unit 280, the controller 290 may control the display unit 210 to move the highlight in a direction corresponding to the user's manipulation, and to move the plurality of items in the opposite direction of the direction corresponding to the user's manipulation. Here, the user's manipulation for moving the highlight received through the input unit 280 may be a user's manipulation of selecting a direction key among up, down, left, and right direction keys.

For example, if a user's manipulation for moving a highlight to the right is input through the input unit 280 when a list as shown in FIG. 3A is displayed, the controller 290 may move, as shown in FIG. 3B, the highlight positioned on the first item 310-1 to the second item 310-2 positioned at the right side of the first item 310-1. Also, the controller 290 may move all items displayed on the display unit 210 to the left, while moving the highlight. That is, as shown in FIG. 3B, the controller 290 may move the first through fourth items 310-1 through 310-4 and the eleventh through fourteenth items 310-11 through 310-14 to the left which is opposite to the direction of the user's manipulation, and newly display the fifth item 310-5 and the fifteenth item 310-15. At this time, parts of the first item 310-1 and the eleventh item 310-11 are not displayed.

Also, if a user's manipulation for again moving the highlight to the right is input through the input unit 280 when a list as shown in FIG. 3B is displayed, the controller 290 may move, as shown in FIG. 3C, the highlight positioned on the second item 310-2 to the third item 310-3 positioned at the right side of the second item 310-2, and move the first through fifth items 310-1 through 310-5 and the eleventh through fifteenth items 310-11 through 310-15 to the left which is opposite to the direction of the user's manipulation. At this time, the first item 310-1 and the eleventh item 310-11 may disappear from the display screen.

For example, the controller 290 may determine the movement distance of the highlight based on the number of the plurality of items included in the list. In detail, if a plurality of items included in a list are arranged horizontally, and one row of the list includes N items, the controller 290 may determine 1/N of the width of the list as the movement distance of the highlight. Likewise, if a plurality of items included in a list are arranged vertically, and one column of the list includes M items, the controller 290 may determine 1/M of the height of the list as the movement distance of the highlight.

For example, if a plurality of items included in a list are, as shown in FIG. 3A, arranged horizontally, and one row of the list includes 10 items, the controller 120 may determine 1/10 of the width of the list as the movement distance of a highlight.

At this time, the controller 290 may move the plurality of items by the movement distance of the highlight in the opposite direction of the movement direction of the highlight. That is, if a user's manipulation for moving a highlight to the right is input through the input unit 280, the controller 290 may move the highlight by 1/10 of the width of a list to the right, and move a plurality of items by 1/10 of the width of the list to the left.

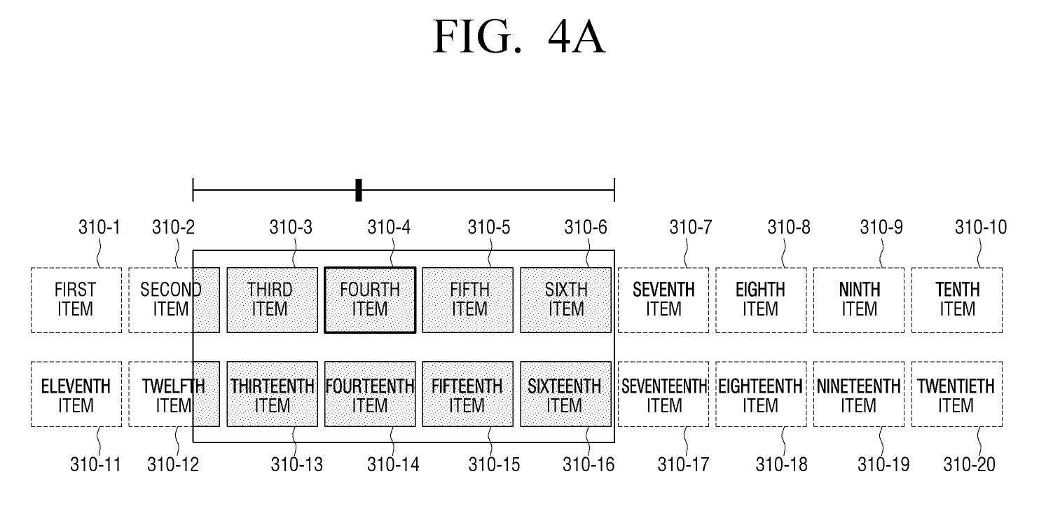

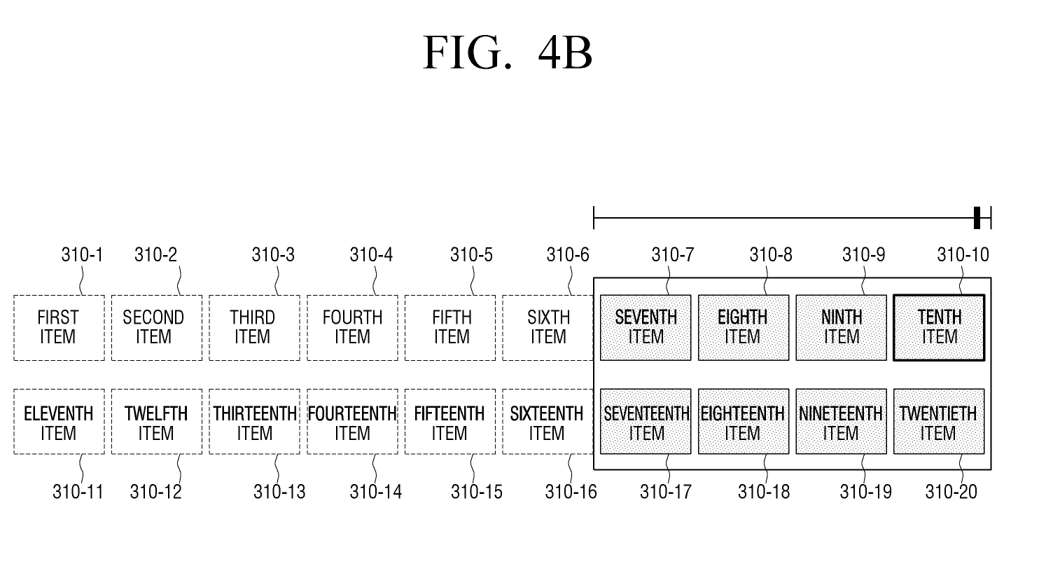

As described above, since the movement distance of a highlight is adjusted according to the number of items, the position of a highlight can represent the relative position of the corresponding item. In detail, as shown in FIG. 4A, if a row includes 10 items, a highlight on the fourth item 310-4 may be positioned at a point corresponding to 4/10 of the width of the row. Also, as shown in FIG. 4B, if a highlight is positioned on the tenth item 310-10, the highlight may be positioned at a point corresponding to 10/10 of the width of the row.

Accordingly, the user may determine the relative position of an item overlapped by a highlight, according to the position of the highlight. That is, although there is no slide bar, the user can recognize the relative position of a current item.

In particular, in order for a user to better recognize the relative positions of a plurality of items, the controller 290 may control the display unit 210 to display an indicator (for example, an arrow) at the center area of the items.

In detail, if a plurality of items included in a list are arranged horizontally, the controller 290 may control the display unit 210 to display an indicator at the center area of the items in the width direction, whereas if a plurality of items included in a list are arranged vertically, the controller 290 may control the display unit 210 to display an indicator at the center area of the items in the height direction.

As described above, by moving a highlight in a direction corresponding to a user's manipulation, and moving a plurality of items in the opposite direction of the direction corresponding to the user's manipulation, a user may successively check items adjacent to an item on which the highlight is positioned, and maintain continuity of search since no screen change is needed. Also, by determining the movement distance of a highlight according to the number of items, a user may recognize the relative position of an item on which a highlight is positioned, without checking a separate UI such as a slide bar.

Meanwhile, FIGS. 3A through 4B relate to an embodiment in which a plurality of items included in a list are arranged horizontally, however, the technical concept of the present invention may be also applied to an embodiment in which a plurality of items included in a list are arranged vertically.

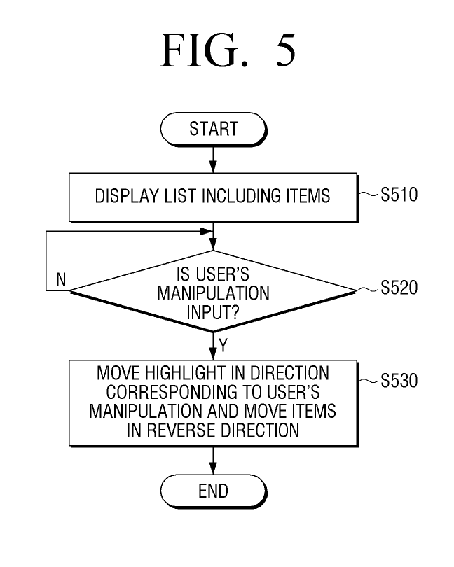

Hereinafter, a list display method of the display device 200 (see FIG. 2) will be described with reference to FIG. 5.

First, the display device 200 displays a list including a plurality of items (S510). At this time, the display device 200 may display some of the plurality of items since it cannot display all of the plurality of items on a display screen. Also, the display device 200 may display a highlight on one of the plurality of items.

Also, the display device 200 may determine whether a user's manipulation is input (S520). The user's manipulation may be a command for moving the highlight in one direction among up, down, left, and right directions.

If a user's manipulation is input (S520-Y), the display device 200 moves the highlight in a direction corresponding to the user's manipulation, and moves the plurality of items in the opposite direction of the direction corresponding to the user's manipulation (S530). In detail, if a user's command for moving a highlight to the right is input when a list as shown in FIG. 3A is displayed, the display device 200 may move the highlight to another item positioned at the right side, and move the plurality of items to the left.

Also, the display device 200 may determine the movement distance of a highlight according to the number of items included in a list. For example, if a plurality of items included in a list are arranged horizontally, and one row of the list includes N items, the display device 200 may determine 1/N of the width of the list as the movement distance of a highlight.

According to an exemplary embodiment, as described above, a user may maintain continuity of search with respect to items included in a list even when moving a highlight. Also, the user may recognize the relative position of an item on which a highlight is currently positioned, with respect to all items.

Also, the list display method of the display device 200, as described above, may be implemented as a program, and provided in the display device 200.

In detail, there may be provided a non-transitory computer readable medium storing a program including a first display step of displaying a list including a plurality of items; and a second display step of moving, if a user's manipulating is input, a highlight displayed on one of the plurality of items to another item in a direction corresponding to the user's manipulation, and moving the plurality of items in the opposite direction of the direction corresponding to the user's manipulation.

The non-transitory computer readable medium is not a medium that stores data temporarily, such as a register, a cache, a memory, etc., but a medium that stores data semi-permanently and allows a machine to read the data. In detail, various kinds of applications or programs, as described above, may be stored in a non-transitory computer readable medium, such as a compact disc (CD), a digital versatile disc (DVD), a hard disk, a Blu-ray disc, a universal serial bus (USB), a memory card, a ROM, etc.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method, comprising:
a first display operation of displaying a list including a plurality of items; and
a second display operation of moving, if a manipulation is input, a highlight displayed on one item of the plurality of items to another item in a direction corresponding to the manipulation, and moving the plurality of items in an opposite direction of the direction corresponding to the manipulation.

2. The method of claim 1, wherein the list is a list in which some of the plurality of items are displayed on a display screen.

3. The method of claim 1, wherein the second display operation comprises determining a movement distance of the highlight using a number of the plurality of items included in the list.

4. The method of claim 3, wherein, if the plurality of items included in the list are arranged horizontally, and a row of the list includes N items, the determining of the movement distance of the highlight comprises determining 1/N of the width of the list as the movement distance of the highlight.

5. The method of claim 3, wherein, if the plurality of items included in the list are arranged vertically, and a column of the list includes M items, the determining of the movement distance of the highlight comprises determining 1/M of the height of the list as the movement distance of the highlight.

6. The method of claim 1, wherein, if the plurality of items included in the list are arranged horizontally, an indicator is displayed at a first center area of the plurality of items in a width direction, and if the plurality of items included in the list are arranged vertically, an indicator is displayed at a second center area of the plurality of items in a height direction.

7. A device comprising:
a display configured to display a list including a plurality of items;
an inputter configured to receive a manipulation; and
a controller configured to move, if the manipulation is input through the inputter, a highlight displayed on one item of the plurality of items to another item in a direction corresponding to the manipulation, and to move the plurality of items in a opposite direction of the direction corresponding to the manipulation.

8. The device of claim 7, wherein the list is a list in which some of the plurality of items are displayed on a display screen.

9. The device of claim 7, wherein the controller determines a movement distance of the highlight using a number of the plurality of items included in the list.

10. The device of claim 9, wherein, if the plurality of items included in the list are arranged horizontally, and a row of the list includes N items, the controller determines 1/N of the width of the list as a movement distance of the highlight.

11. The device of claim 9, wherein, if the plurality of items included in the list are arranged vertically, and a column of the list includes M items, the controller determines 1/M of the height of the list as the movement distance of the highlight.

12. The device of claim 7, wherein, if the plurality of items included in the list are arranged horizontally, the controller displays an indicator at a first center area of the plurality of items in a width direction, and
if the plurality of items included in the list are arranged vertically, the controller displays an indicator at a second center area of the plurality of items in a height direction.

13. The method of claim 1, wherein the manipulation is performed by a user.

14. The device of claim 7, wherein the manipulation is performed by a user.
